(19) United States
(12) Patent Application Publication
(10) Pub. No.: US 2013/0146626 A1
(43) Pub. Date: Jun. 13, 2013

(54) Apparatus and Method for Storing an Orthodontic Appliance

(71) Applicants: Bella Shen Garnett, San Francisco, CA (US); Aresa Pecot, San Francisco, CA (US)

(72) Inventors: Bella Shen Garnett, San Francisco, CA (US); Aresa Pecot, San Francisco, CA (US)

(21) Appl. No.: 13/708,630

(22) Filed: Dec. 7, 2012

Related U.S. Application Data
(60) Provisional application No. 61/568,907, filed on Dec. 9, 2011.

(51) Int. Cl. A61C 19/02

(52) U.S. Cl. CPC A61C 19/02
USPC 224/219

(57) ABSTRACT

An apparatus and method for storing and transporting an orthodontic appliance. The apparatus comprises two halves, specifically a top portion and a bottom portion. The top portion is joined to the bottom portion to substantially form a pocket. The top portion and bottom portion also comprise a zipper for temporarily binding the portions together and for closing and opening the pouch. Both the top portion and bottom portion comprise a soft padded surface disposed along their interior so that when the zipper is actuated, the pouch forms a soft interior pocket for an orthodontic appliance. The pouch further comprises a wrist strap. The wrist strap allows the user to strap the pouch to their wrist and carry the orthodontic appliance inside in a safe and sanitary manner.

### RELATED APPLICATIONS

The present application is related to U.S. Provisional Patent Application, Ser. No. 61/568,907, filed on Dec. 9, 2011, which is incorporated herein by reference and to which priority is claimed pursuant to 35 USC 119.

### BACKGROUND

1. Field of the Technology

The disclosure relates to the field of storing and maintaining orthodontic appliances, specifically to flexible pouches that may also be worn by the user.

2. Description of the Prior Art

Orthodontic appliances such as retainers, aligner trays, and the like have traditionally been stored when not in use by a user in a retainer box. A retainer box as is known in the art is a single piece of plastic, molded into a three dimensional box that roughly approximates the shape of the appliance. The box typically comprises a hinged lid which snaps shut into a temporary locked position. While the box does provide some protection from dirt and outside bacteria from entering the box and making contact with the appliance, if any moisture is left on the appliance or accidentally gets inside, the box will not prevent bacteria from growing on the appliance.

Furthermore, the box is not conducive for transporting the orthodontic appliance from location to location. Typically the box does not comprise any handles or means for grasping by user, and because the box is comprised of hard plastic, the orthodontic appliance may bounce around inside of it, thus possibly damaging the appliance during transit.

What is needed is a means for safely storing an orthodontic appliance that lowers the chances for contamination while also safely permitting the user to transport the device as needed.

### BRIEF SUMMARY

The current invention includes an apparatus for containing and carrying an orthodontic appliance. The apparatus includes a top portion, a bottom portion coupled to the top portion, and a wrist strap coupled to the bottom portion. The wrist strap itself has a removable means for coupling to the wrist of a user, preferably a portion of hook and latch fabric.

In one embodiment, the top portion and the bottom portion of the apparatus are removably coupled to each other with a zipper, the coupled top and bottom portions thus forming a pouch. Both the top portion and bottom portion of the apparatus each comprise an inner padded surface and an outer water resistant surface.

In one embodiment, the bottom surface of the apparatus includes a buckle for threading the wrist strap therethough.

The invention also includes a method for storing and transporting an orthodontic appliance. The method includes coupling a pouch to the wrist of a user, inserting the orthodontic appliance into the pouch, and closing the pouch.

In one embodiment, the method step of coupling the pouch to the wrist of user comprises placing a bottom portion of the pouch against the wrist of the user. A wrist strap is then placed over the wrist of the user which is then threaded through a buckle coupled to the bottom portion of the pouch. The wrist strap is then folded on top of itself and then coupled to itself, preferably by engaging two portions of a hook and latch fabric disposed on the wrist strap to each other.

In another embodiment, closing the pouch comprises actuating a zipper disposed on the pouch.

In still another embodiment, the method also includes removably coupling a top portion and a bottom portion of the pouch together, preferably by actuating a zipper disposed between the top portion and the bottom portion.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a frontal view of the current pouch when in a disassembled configuration.

FIG. 2 is a top view of the assembled pouch, with the pouch opened to receive an orthodontic appliance.

FIG. 3 is a top view of the pouch seen in FIG. 2 with an orthodontic appliance disposed inside.

FIG. 4 is a bottom view of the pouch seen in FIG. 1 after being removably coupled to the arm of a user.

FIG. 5 is a top view of the pouch seen in FIG. 1 after being removably coupled to the arm of a user.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

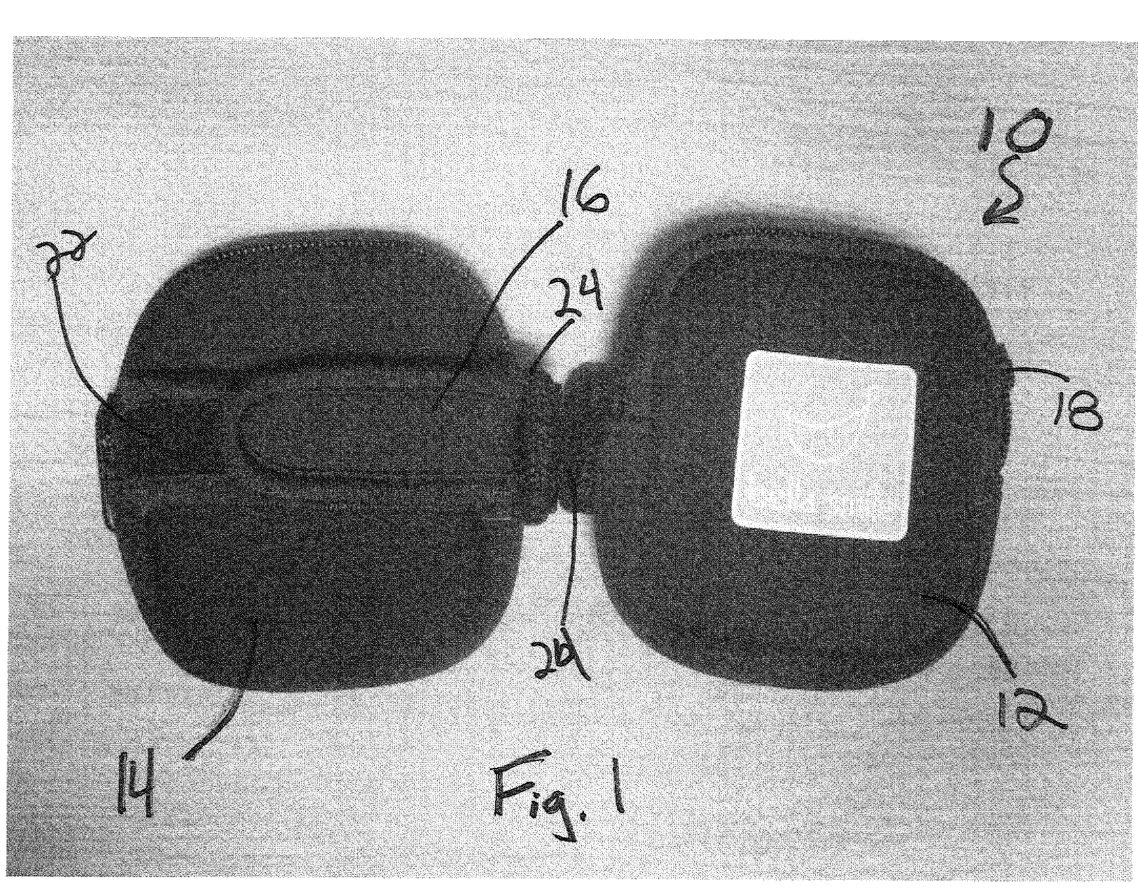

The current device is an orthodontic appliance pouch seen in FIG. 1 and is generally denoted by reference numeral 10. The top and bottom of the pouch 10 are seen in FIG. 1.

The pouch 10 comprises two halves, specifically a top portion 12 and a bottom portion 14. The top portion 12 is joined to the bottom portion 14 to substantially form a pocket. The top portion 12 and bottom portion 14 also comprise a zipper 18 for temporarily binding the portions 12, 14 together and for closing and opening the pouch 10. Each portion 12, 14 comprises a row of teeth so that when properly aligned, the slider portion of the zipper 18 may be actuated, thus coupling or separating the rows of teeth as is well known in the art and thereby closing or opening the pouch 10, respectively. The outer surfaces of the top portion 12 and bottom portion 14 are preferably comprised of light weight, washable, durable material such as nylon, cotton, or other similar fabrics or fabric blends now known or later devised. In another embodiment, the material comprising the pouch 10 is waterproof or water resistant.

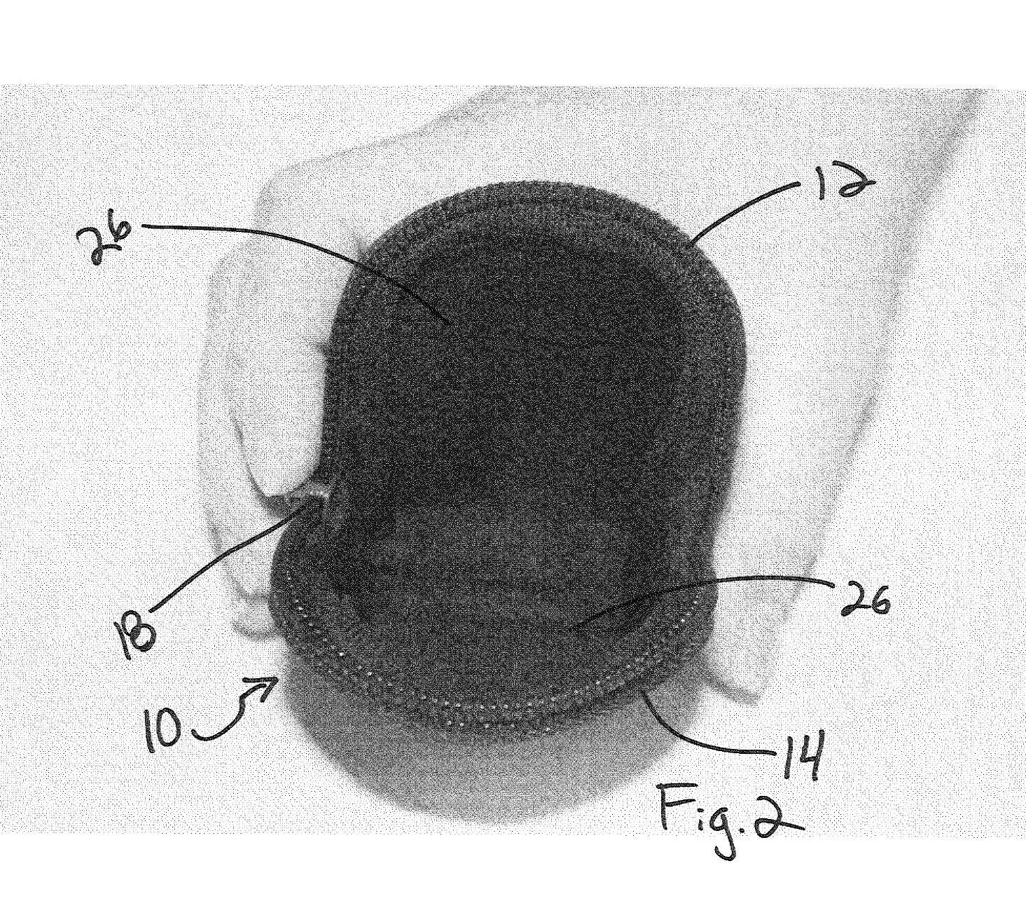

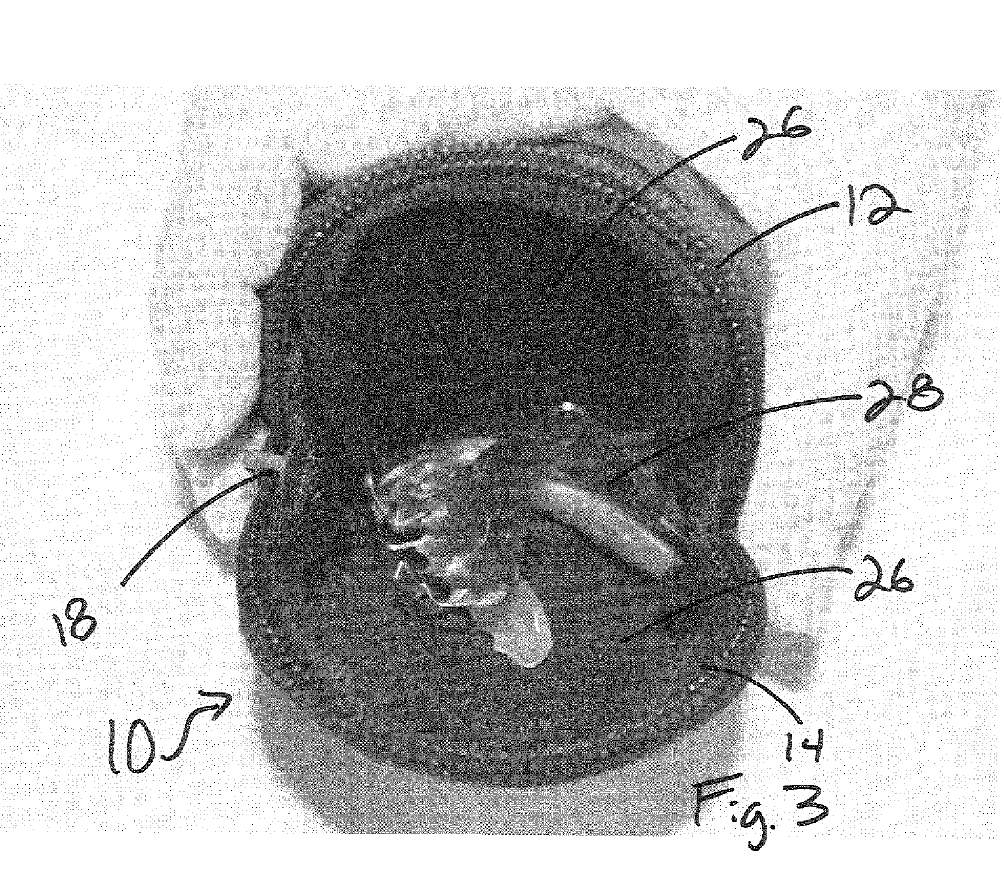

The inside of the pouch 10 may be seen in FIGS. 2 and 3. Both the top portion 12 and bottom portion 14 comprise a soft padded surface 26 disposed along their interior so that when the zipper 18 is actuated, the pouch 10 forms a soft interior pocket for an orthodontic appliance 28 as seen in FIG. 3. While the orthodontic appliance 28 seen in FIG. 3 is a retainer device, it is to be expressly understood that other orthodontic appliances now known or later devised may also be inserted into the pouch 10 without departing from the original spirit and scope of the invention.

The bottom portion 14 of the pouch 10 further comprises a wrist strap 16. The wrist strap 16 is a band of material threaded through a buckle 24 disposed on the bottom portion 14 as seen in FIG. 1 and then folded back on itself. The wrist strap 16 comprises a hook and loop fabric strip 22 on its inner surface so that when folded back upon itself through the buckle 24, the wrist strap 16 may be tightened and firmly coupled about the wrist of a user as is further detailed below. While a hook and loop fabric strip 22 is seen in FIG. 1 for temporarily coupling the wrist strap 16 to itself, this is meant to be for illustrative purposes only. Other means for coupling such as snap buttons, adhesive, or the like may be used without departing from the original spirit or scope of the invention.

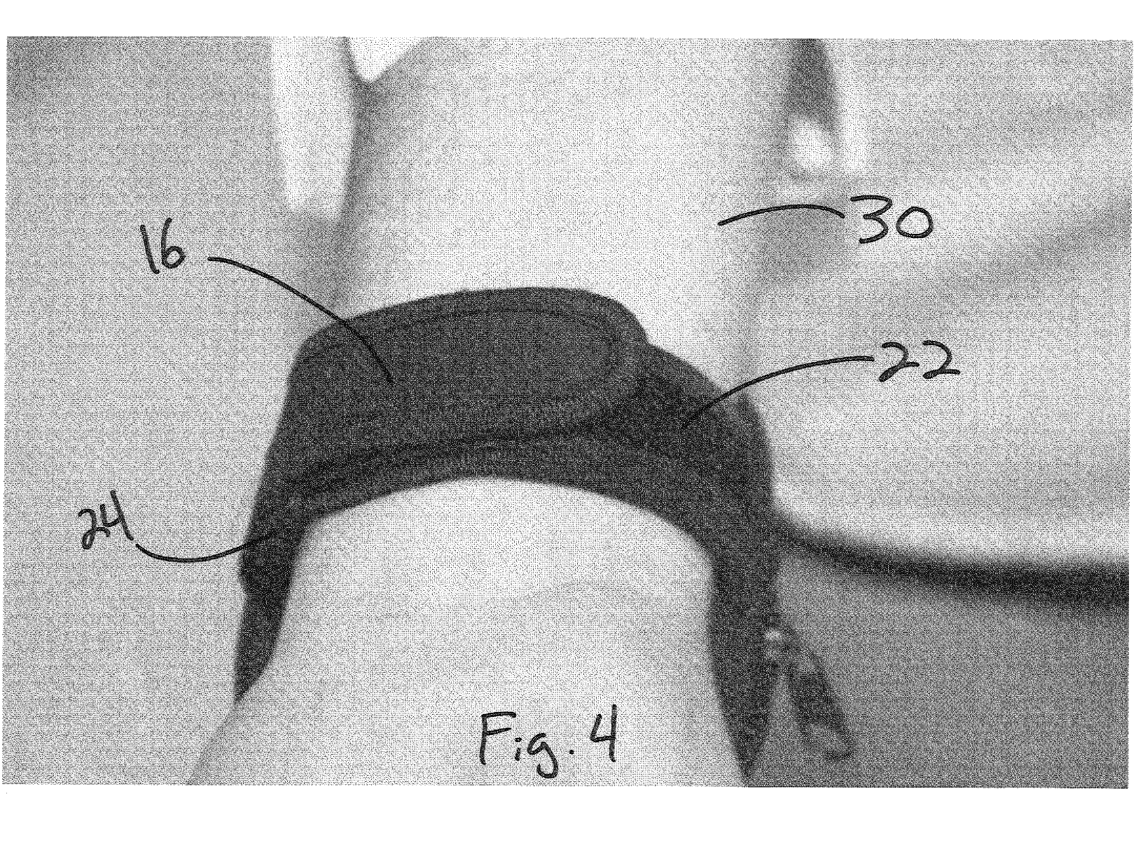

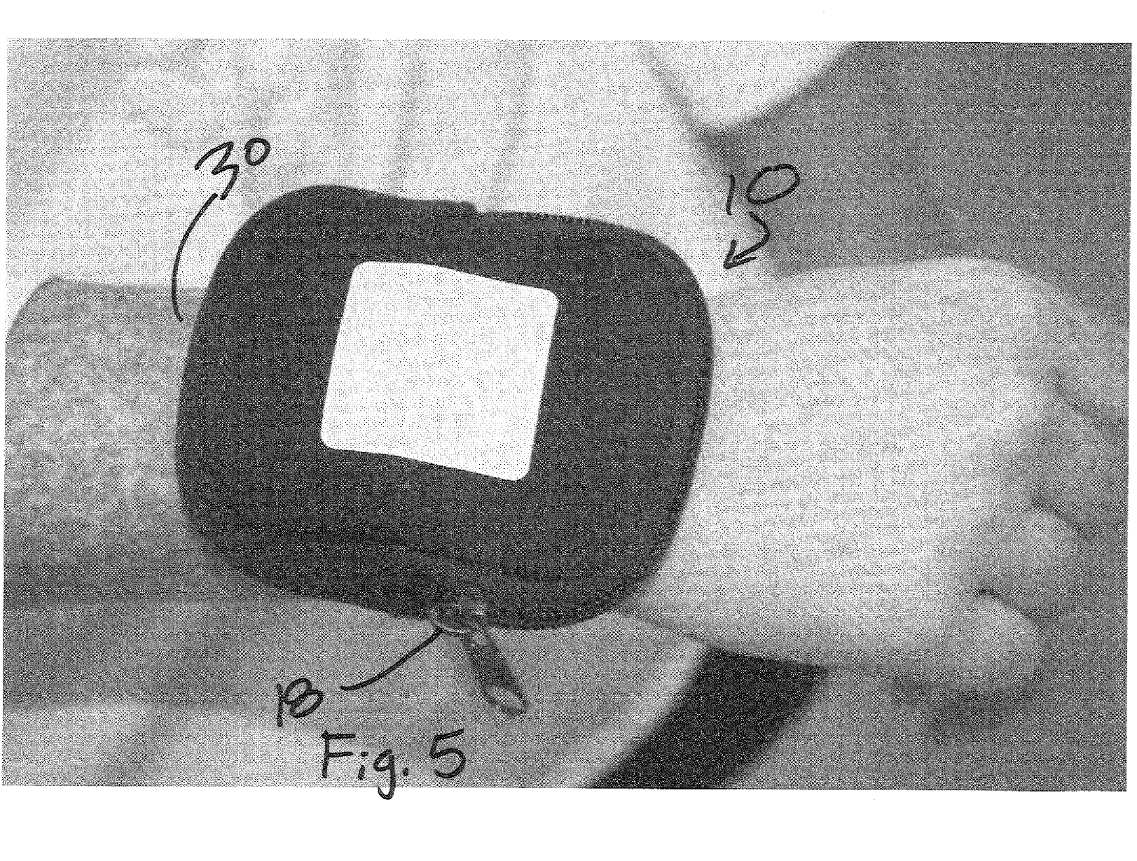

To use the pouch 10, a user inserts their hand and wrist 30 between the bottom portion 14 of the pouch 10 and the wrist strap 16. The user then adjusts the wrist strap 16 by pulling the wrist strap 16 through the buckle 24 until a tight yet comfortable fit is obtained. The user then presses the wrist strap 16 against itself as seen in FIG. 4, engaging the hook and loop fabric strip 22 and maintaining the pouch 10 in a fixed position on the user's wrist 30. The user may insert an orthodontic appliance 28 into the interior of the pouch 10 and then actuate the zipper 18 to close the pouch 10 and thus maintain the orthodontic appliance 28 in a safe and accessible position located on the user's wrist 30 as seen in FIG. 5. With the pouch 10 firmly attached, the user may then continue about their daily activities without the fear of dropping or misplacing their orthodontic appliance 28. The soft padded surface 26 protects the orthodontic appliance 28 from minor bumps and other forms of physical contact experienced by the pouch 10. Additionally, because the pouch 10 provides a clean, dry interior pocket for the orthodontic appliance 28, the user may have confidence that their orthodontic appliance 28 is free from outside contaminants or moisture which may contain germs, dirt, or other undesirable substances while in the pouch 10.

If the user requires the orthodontic appliance 28, the zipper 18 is actuated in the opposing direction and the pouch 10 is opened, thus allowing direct access for the orthodontic appliance 28 to be pulled out of the pouch 10. To remove the pouch 10 from the wrist 30 of the user, the wrist strap 16 is pulled upwards, disengaging the hook and loop fabric strip 22 from itself. The user then pulls the wrist strap 16 back through the buckle 24 and loosening the hold of the pouch 10 around the user's wrist 30. The user then pulls their hand and wrist 30 out from under the wrist strap 16 and clear of the pouch 10.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An apparatus for containing and carrying an orthodontic appliance comprising:
a top portion;
a bottom portion coupled to the top portion; and
a wrist strap coupled to the bottom portion.

2. The apparatus of claim 1 where the wrist strap comprises a removable means for coupling to the wrist of a user.

3. The apparatus of claim 2 where the removable means for coupling is a portion of hook and latch fabric.

4. The apparatus of claim 1 where the top portion and the bottom portion are removably coupled to each other with a zipper, the coupled top and bottom portions forming a pouch.

5. The apparatus of claim 1 where the top portion and bottom portion each comprise an inner padded surface.

6. The apparatus of claim 1 where the top portion and bottom portion each comprise an outer water resistant surface.

7. The apparatus of claim 1 where the bottom surface comprises a buckle for threading the wrist strap therethough.

8. A method for storing and transporting an orthodontic appliance comprising:
coupling a pouch to the wrist of a user;
inserting the orthodontic appliance into the pouch; and
closing the pouch.

9. The method of claim 8 where coupling the pouch to the wrist of user comprises:
placing a bottom portion of the pouch against the wrist of the user;
placing a wrist strap over the wrist of the user;
threading the wrist strap through a buckle coupled to the bottom portion of the pouch;
folding the wrist strap over on top of itself; and
coupling the wrist strap to itself.

10. The method of claim 9 where coupling the wrist strap to itself comprises engaging two portions of a hook and latch fabric disposed on the wrist strap to each other.

11. The method of claim 8 where closing the pouch comprises actuating a zipper disposed on the pouch.

12. The method of claim 8 further comprising removably coupling a top portion and a bottom portion of the pouch together.

13. The method of claim 12 where the means for coupling the top portion and the bottom portion of the pouch together further comprises actuating a zipper disposed between the top portion and the bottom portion.
